(19) United States
(12) Patent Application Publication
(10) Pub. No.: US 2009/0258334 A1
(43) Pub. Date: Oct. 15, 2009

(54) Human amalgamation ratiocination process sublimation system

(76) Inventor: Ken A. Pyne, Tell City, IN (US)

Correspondence Address: Gary K. Price, Esq., Terell, Baugh, Salmon & Born, LLP, 700 South Green River Road, Suite 2000, Evansville, IN, 47715, US

(21) Appl. No.: 12/384,956

(22) Filed: Apr. 10, 2009

Related U.S. Application Data
(60) Provisional application No. 61/123,641, filed on Apr. 10, 2008.

(51) Int. Cl. G09B 19/00

(52) U.S. Cl. 434/236

(57) ABSTRACT

A computer implemented process for evaluating a person's employment potential including the steps of:

evaluating the person's willingness to relocate based on a first set of questions and expressing that willingness as a first number;
evaluating the person's ability to work a length of time each day based on a second set of questions and expressing that willingness as a second number;
evaluating a person's sense of influence and control based on a drawing test and expressing that sense as a third number;
evaluating a person's current employment characteristics in terms of company opportunity, advancement opportunity, work satisfaction and compensation and mathematically expressing the employment characteristics as a fourth number;
and making a career choice based on mathematically combining the first, second, third and fourth numbers.

### CROSS REFERENCES TO RELATED APPLICATIONS

U.S. Provisional Application for Patent No. 61/123,641, filed Apr. 10, 2008, with title “System for Human Process Ratiocination Management” which is hereby incorporated by reference. Applicant claims priority pursuant to 35 U.S.C. par. 119(e)(i).

### STATEMENT AS TO RIGHTS TO INVENTIONS MADE UNDER FEDERALLY SPONSORED RESEARCH AND DEVELOPMENT

Not Applicable

### BRIEF DESCRIPTION OF THE PRIOR ART

Traditionally, human capital business endeavors to interview a candidate using a set of standard questions, add this information to various records of prior employment and education, and submit the candidate to a list of employers with whom they have a relationship. Employers may solicit the submission of possible candidates also using a set of standard job descriptions for positions that have been vacated by former employees, or may in fact be creating new jobs for which they have no prior performance requirements.

Those familiar with the art will know the historically low success rate of the traditional approach to human resource producer automation processes for numerous reasons. The lack of an objective and accurate profiling process may produce an inaccurate or incomplete representation of the actual potentials and aptitudes of the prospective employee. These attributes are most likely to be tested in actual and heretofore untried employment situations that may produce unsatisfactory performance that may also result in termination of that employee or an undesirable outcome value. This turnover is extremely costly to the employer, frustrating for the employee, and has been unresolved by the prior art. All parties have sought to deflect accountability for measuring manpower soft skills such as leadership ability, persistence or creativity for example. The human capital industry has long voiced an unresolved need for an Internet or Intranet based software and database system that could provide a high level of resolution and accuracy in the ratiocination profiling of potential employment candidates' soft skills without psychological typecasting. The constantly changing pool of potential employees has also voiced a need to better understand employers.

The principle weakness of the traditional approach to automated human resource evaluation processes is the nature of the original data source which is text information, or a resume. For example, job candidates prepare resumes that detail hard skill abilities and often exaggerate soft skills, (leadership skills, gets along with co-workers, works well under pressure), because they are motivated to present themselves in the best possible light to get an interview. Since there is no requirement for standardization of the content or presentation of resumes, they end up being highly subjective and incomplete presentations of experience and qualifications. Information that supports the image the individual wants to portray is included—whereas other information is omitted. In some cases, individuals may over represent or under represent certain aspects of their qualifications, or their experience. This coupled psychological typecasting only adds to the groupthink paradox and builds group dissonance, walls or silos.

Another significant problem with conventional technology for human capital assessment is the use of historical discrete data on the individual's qualifications, education, or experience. Much of this data may in fact be the product of poor choices made from accepting or extending employment from the lack of soft skill transparency needed and from such, organizations lose billions of dollars in employment turnaround and the candidate's unemployment potential increases from being considered as a job hopper. Conventional technology searches for key words or phrases that indicate the nature of the data as it has been recorded. Once key words or phrases are found, additional instructions govern the extraction of data and insertion into a database. For example, if a text string contains the word “University” the software may have rules that interpret this as relating to university-level education and extracts the text string for insertion into the database relating to education. Since resumes use a variety of approaches for expressing information on qualifications, education and experience, each of these approaches has to be anticipated and programmed. Unfortunately, it is almost impossible to anticipate all the variations possibly resulting in incorrect or incomplete data extraction. Since the data extraction process is prone to error, human intervention is required to assure database quality. The intervention takes the form of reviewing the database and comparison with the original resume. This intervention is time-consuming and expensive. Even if the data extraction process goes smoothly, the resulting database will be incomplete due to the lack of a standardized and complete presentation of information on the original resume and its suitability. Compounded human intervention and subsequent errors result and cause additional miscommunication of information that skew the qualifications, based on the exaggerated information provided.

Another significant problem with the conventional technology for human capital or resource assessment is that text file information or text file resumes, as data is the normalization of data once it has been extracted and stored in the database. Since different people would treat the original information throughout the employment placement process subjectively, the challenge is to generate effective, accurate, and unambiguous data. Normalization is the process of rendering data so that it is directly comparable from one candidate to another. For example, two candidates may have virtually identical work histories, skills, and educational qualifications, but one employee may place his highest emphasis on job security, while the other places his highest emphasis on advancement. Those familiar with the art will appreciate the lack of accurate electronic tools for accurately detecting and representing this difference in priorities between the two employees. Such differences would most likely have an effect on the rapport between the employee and the employer, thus resulting in costly turnover or diminished production from the relationship. The ability of the individual data interpreter, or the data preparer, to represent these traits has been extremely problematic in the human capital or resource assessment industry.

Still another significant problem with conventional technology for human capital or resource assessment is that text file information or text file resumes lack standardization by industry. Certain industries require or focus on different skill-sets and other qualifications as being primary profile parameters for hiring indicators. Since text file resumes are prepared in an exaggerated fashion of soft skills, it is difficult to apply the objective standards for soft skill hiring in a given industry and by job description.

Yet another significant problem with conventional technology is the lack of employment placement process matching or error-proofing capabilities of automation approaches, as it typically addresses characteristics that are based on registration, licensing, certification, or the granting of degrees or diplomas rather than the more teleological, and perhaps vital, aspects of the human resource assessment. Short-term employment, matching of the qualitative and quantitative characteristics of the candidate to the characteristics of the employer and the particular employment position within that organization is critical to the art. Using test file information or text file resume-based databases, and automated screening processes produce poor results because of the poor quality of data. Candidates selected by the automated screening process have traditionally demonstrated a low percentage of success in the employment industry. That is to say, the employment histories of automatically placed candidates have high turnover and/or lack of advancement inside any particular organization as they are shuffled through a series of marginal successes. This is believed to be a direct result of the inability of conventional human resource assessment technology. Generally, the screening thresholds must be set low or run the risk of rejecting qualified candidates, thus greatly increasing the number of resumes that have to be reviewed by human resources people, thus increasing the time and cost needed to arrive at a pool of qualifies candidates. Further, once the pool of qualified candidates is defined, the matching process is almost entirely manual due to the lack of rigorous data with which to quantitatively rank candidate's qualifications versus the requirements of a position.

Another significant problem with the conventional technology for human resource assessment is the lack of real time correlation between the Placement Group, the Employer, and the potential or current Employee. Each party has an independent system for collecting and processing data. The lack of standardization between these three processes results in a high level of errors in the employment placement process.

Another significant problem with the conventional technology for human resource assessment is that the Employee searching for employment has no effective way of determining the purpose driven values of the Employer. The Employer expends significant design and marketing capital to create a mission statement, creed, or other such philosophy about their organization, but the purpose of the Employer cannot be revealed to the candidate using the existing technology.

Another significant problem with the conventional technology for human resource assessment is that the staffing or outside-placement vendor may work with several existing employers for whom it has provided candidates in the past. Those familiar with the art will know that determining the purpose of an Employer by a staffing group is nearly impossible with the current technology, often relying on social contact and significant expense to find out whether security, money, advancement, technology or integrity are ranked accurately as a purpose of the organization. This current problem of the employment placement process is the primary cause behind errors in the employment placement process and retention

Still another significant problem with the conventional technology for human resource assessment is that the staffing group may have no prior experience with the new candidate. This has resulted in an employment placement process that is based on trial and error and the gathering of hard skill and training information and does not offer any solution toward knowing the purpose of the Employer, the Employee, or the outside placement vendor.

Still another significant problem with the conventional technology for human resource assessment is that the career consultant or personnel recruiter must rely upon individual interviewing skills to coach, collect, treat, and report data. There is no normalization of the interview process, the treatment, or reporting of this data, therefore, the process of employment improvement is highly variable and not standardized thus nearly impossible to quantify. This yields ambiguous and even misleading results, providing a significant percentage of participants with little or no satisfaction in the process. Although the work history and educational transcripts are academic and objective in value, the process purpose values of the employer and candidate are not apparent and the recruiters can easily skew what until now could not be transparently quantified.

Still another significant problem with the conventional technology for human capital or resource assessment is that the Management Consultant does not have access to the tools required to collect, treat, and report motive values or purposes of the organizations with which he or she may be working. Data on the current production, margins, labor allocations, customer base and other inputs to the overall performance of the organization may be available. However, the data on the human satisfaction, individual potential for improvement, and even alignment of individual purpose with that of the organization cannot be determined with the current human assessment technology. Further, the present solution for lack of desired productivity or level of rapport in an organization has traditionally been to downsize, terminate, or relocate the particular operation of the company.

Still another significant problem with the conventional technology for human resource assessment is that the typical entity interface lacks the ability to engage the entity in a manner that represents the importance, philosophy, or strategy of the employment placement process. Hard skill data is collected via electronic forms, but the format is without purpose and has no value to entertain or inform the entity as to the nature or purpose of the data being collected. The high level of errors in the employment placement process is accepted by the population of entities as normal or an expected risk of seeking, facilitating or granting employment apparently largely because the data being required by the currently inadequate entity interface is the same for all technologies, regardless of provider.

Still another significant problem with the conventional technology for human capital or resource assessment is that there is no normalized way to align the purpose or human process ratiocination of the Employer with the Employee, or Candidate. The normalization of the human process ratiocination and purpose of each party through automatic electronic means to create a pattern of symbols or indicators that might be matched objectively or subjectively does not currently exist in the employment placement process without expensive and unpopular psychological typecasting.

As can be seen, there is a need for an improved system and method of collected data related to human soft skills, to quantify the data and to match those data against the purpose of an employer.

### SUMMARY OF THE INVENTION

The present invention is directed to a computer implemented process for evaluating a person's employment potential including the steps of:

evaluating the person's willingness to relocate based on a first set of questions and expressing that willingness as a first number;
evaluating the person's ability to work a length of time each day based on a second set of questions and expressing that willingness as a second number;
evaluating a person's sense of influence and control based on a drawing test and expressing that sense as a third number;
evaluating a person's current employment characteristics in terms of company opportunity, advancement opportunity, work satisfaction and compensation and mathematically expressing the employment characteristics as a fourth number; and,
making a career choice based on mathematically combining the first, second, third and fourth numbers.

### BRIEF DESCRIPTION OF THE DRAWINGS

FIG. 1 shows a relational diagram of a portion of the present invention;

FIG. 2 shows a second relational diagram;

FIG. 3 shows a third relational diagram;

FIG. 4 shows a fourth relational diagram;

FIG. 5 shows a flowchart of the system;

FIG. 6 shows details of a portion of the system flowchart;

FIG. 7 shows scoring details;

FIG. 8 shows details of a portion of the system flowchart;

FIG. 9 shows scoring details;

FIG. 10 shows scoring details;

FIG. 11 shows scoring details.

### DESCRIPTION OF THE PREFERRED EMBODIMENT

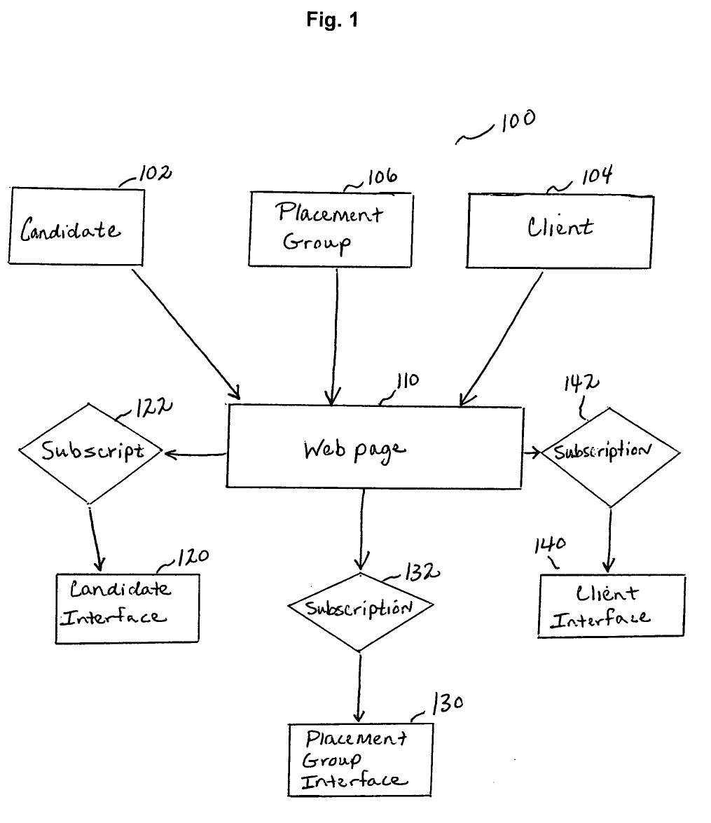

In accordance with the present invention, FIG. 1 shows a basic flow chart of how various users access the system. The term candidate 102 means candidates for employment but might also include current employees of an employer client 104. A placement group 106 such as employee search firms, so called ‘head hunters’ or temporary employers will also have access to an interactive webpage 110. The candidate can create a candidate interface 120 by a subscription 122. The placement group 106 also has an interface 130 created by subscription 132 and the client has an interface 140 created by subscription 142.

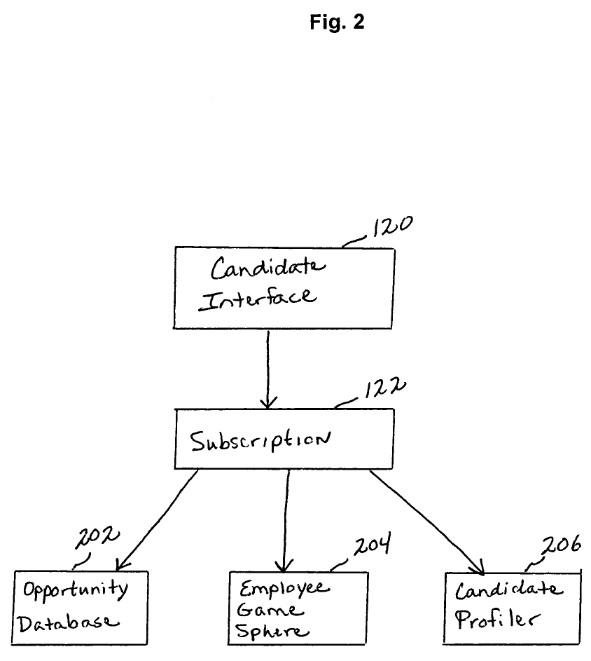

FIG. 2 shows a flow chart of the candidate interface 120. The candidate Interface 120 is designed to be accessible either online by subscription 122 or through an Employer's server, as a free standing installed software, or through the Personnel Placements Group's server. The subscription 122 can include any or all of the opportunity database 202, employee game sphere 204 and candidate profiler 206.

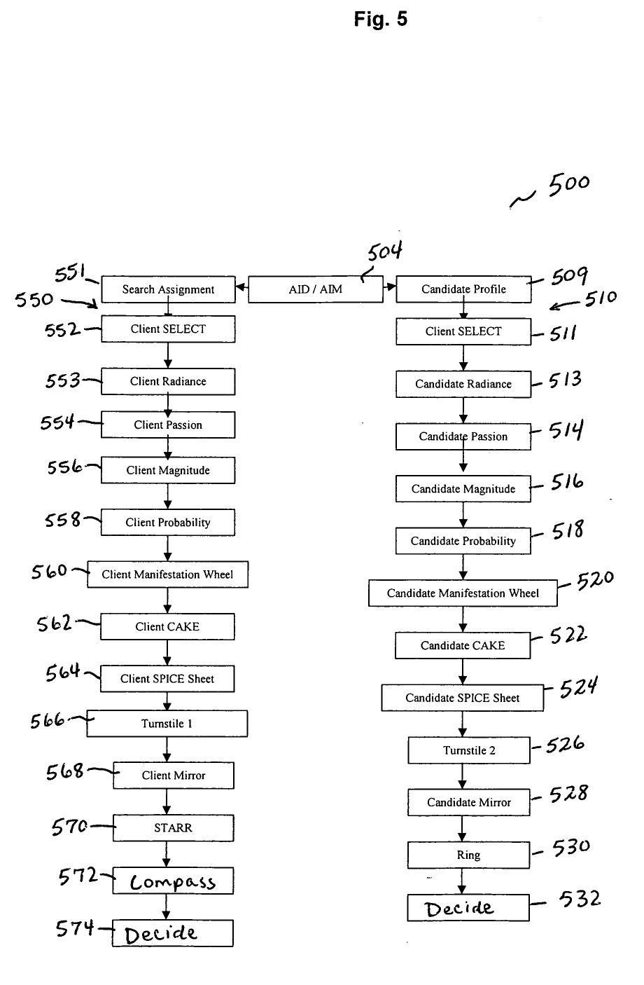

If the candidate or employee accesses the Interface 120 online with the intention of pre-qualifying for possible employment, the PRIZM opportunity database 202 can be designed to prompt the Placement Group 106 to contact the Employee if further action is desired or needed. After the Employee pre-qualifies, he may see that he lacks certain skill sets or training requirements. The PRIZM software (FIG. 5) is designed to prompt the Employee which areas require additional training. This section of the software also utilizes the game sphere 204 and may be sufficient to guide the Employee through an internal process of self-improvement.

The PRIZM software (FIG. 5) will connect the Employee with the Placement Group 106 and prompt him to schedule a series of interactive sessions so that the matching process can be optimized.

The Employee or candidate is provided a proprietary method to obtain an evaluation that will include the following:

A comprehensive personality evaluation that results in a classification. The classification might correspond to a familiar symbol such as a playing piece found in the game of Chess. Each piece and color has a distinct set of characteristics that match the core traits of that person for example.

The main purpose of this is to determine the strengths and weaknesses of the prospective employees, who might be a candidate for employment placement. This is a key evaluation, as the candidate may need certain skills added or counseling to meet the requirements of employment. The value added by the PRIZM process (see FIG. 5) facilitates targeted counseling so that the Candidate achieves a matching employment opportunity as quickly as possible. A link to various training aides, Sublimation and other trait-building systems allows the candidate to grow his abilities and interpersonal skills into the optimum career path.

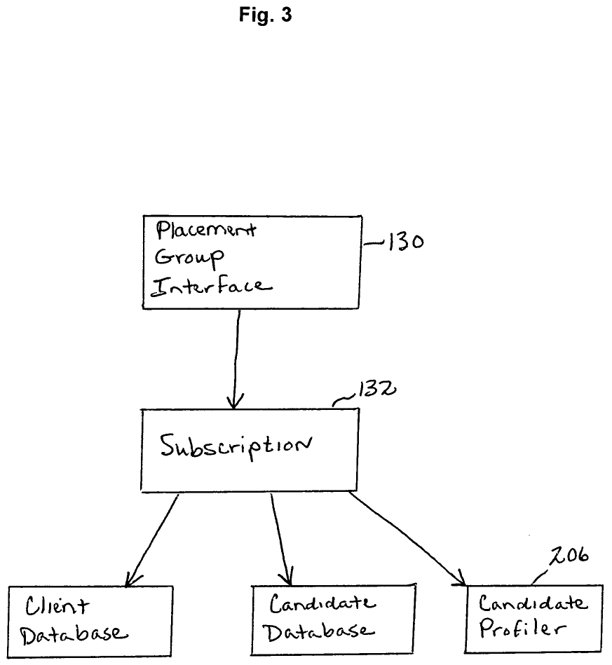

FIG. 3 shows the placement group interface 130. The Placement Group is designed to function as the recruitment agent in the hiring process. It may canvass by various' means to discover suitable candidates for participating in the testing process outlined by the PRIZM process. It is strongly believed that this process will determine the personality traits, employment desires and qualifications of any candidate. Those traits may be matched with employment opportunities with a much higher rate of success than with traditional recruiting methods. This is accomplished by the Placement Group through two processes:
1. Accurately determining the missing skills in the candidate and assigning tasks to the candidate to acquire them. The data for this determination is provided by the PRIZM software. The training and certification for the evaluation is provided by Dynamism.
2. Accurately assessing the employment opportunity so that it matches with optimum effectiveness for the Employer and the Candidate. The data for this assessment is provided by the PRIZM software. The staff of the Employer will participate in the same game software and are individually added to the profile of the Employer. The summation of the staff evaluations is the construct that makes up the Employment opportunity as much as the physical work involved in the opportunity.

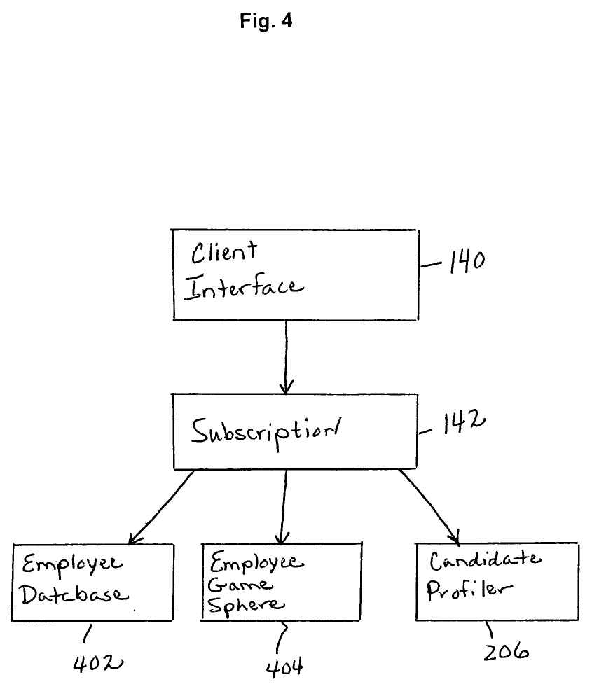

FIG. 4 shows the client interface 140 which can access the web site 110 by subscription 142.

FIG. 5 shows the PRIZM flowchart 500. PRIZM (Presence Realignment Integration Zen Model) is an information orientated probability and predictability process that is derived from an entity's own paradigm. It can be used for staffing; retention, organizational behavior, training, and sublimation processes. It incorporates an entity's perceptions, intentions, energy flow, and thus their current condition in a given time. This information can be used to assess: Life energy flow and productive energy, traits, span of influence to control ratios, current condition, motivations, pattern recognition and resolve, perceptions, current role within their current situation, work ethic, current to future predictability indexing. The information below describes and illustrates the steps in sequence, for the PRIZM.

The candidate process 510 is the steps on the right side of the PRIZM flowchart 500. The first step in the candidate process 510 and the client process 550 (left column) can be the AID/AIM step 504. AID/AIM 504—can be the first process applied in using and conducting PRIZM applications 500. AID/AIM 504 is a communication process that allows clear communication within groups that produces increased efficiency because the barriers within normal communication, and the barriers created by the groupthink phenomenon, are broken down to their core essences. However, the AID/AIM process 504 can be used by an Executive coach, or PRIZM administrator to coach a person through the PRIZM process 500. It also provides a communication alignment between two (2) or more entities to establish communication, strategies, goals, objectives, missions, values, measurables, and statistical information to be processed, and a process for unblocking flows in communication that are later data mined. AID/AIM 504 is also applied to Host Dynamics. Host Dynamics is a concept that incorporates the AID/AIM 504 process as it pertains to the entity's mission statement, giving it a voice, in which entities can align to something larger than themselves. For example, a CEO can decide the direction for his company based on what sequences (discussed later) will be followed for a particular time frame, and use the AID/AIM 504 process to data mine the alignment to his direction. Which allows the entity sublimation.

One example for how this AID/AIM process 504 would be applied is as follows. The entity (coach) will get the attention of the entity (viewer). The viewer will align to the coach for application purposes. The coach will give their transparent intention while the viewer inquires, so the information can de duplicated. The viewer will duplicate the information back to the coach who will measure for understanding of the material or information discussed. The step 504 includes communicating and then testing that communication is understood.

The first step for the client with a search assignment 551 is the SELECT step 552. Select is a time saving process to ascertain whether an entity is ready for a change, has enough interest to explore an opportunity or entity, and/or whether a profile 509 is needed. An employer entity can compare information: potential candidates/clients on universal criteria, how many candidates/clients are in consideration for an assignment, where they are at in the candidate PRIZM process 510, and how they compare. It will be effective in determining if an entity chooses to be interviewed, or who will be interviewed. Criteria scores for candidate side of SELECT range from 1 to 6 (candidate side), and with a maximum score of 36. On the client side the SELECT score range is 1 to 6 for Sell Yourself, and 1 to 5 for the remaining sets with a maximum of 31. If it is ascertained that a SELECT process is warranted, then an entity's score should be at least than 20 (client), and 24 (candidate) to proceed. The SELECT process for the client consists of 6 criteria, which are as follows: 1) Sell the opportunity, 2) Evaluate the Specialty Score, 3) Locomotion to Schedule Management, 4) Evaluate the Acceptable Receptivity, 5) Conceptual Reality/CAKE of Opportunity Score, and 6) Tightness of Relationship. There are also 6 criteria for the candidate Select process 511, which are as follows: 1) Sell the potential opportunity, 2) Evaluate the qualifications, 3) Location considerations, 4) Estimate Family Support, 5) Compensation & Expectations, and 6) Timing Determination.

| Client SELECT Process 552 | Score |
|---|---|
| Sell yourself as the #1 process recruiter in the world | 1 to 6 |
| Evaluate Specialty Score | 1 to 5 |
| Locomotion to Schedule Management | 1 to 5 |
| Evaluate the Acceptable Receptivity | 1 to 5 |
| Conceptual Reality/CAKE of Opportunity Score | 1 to 5 |
| Tightness of Relationship | 1 to 5 |
| | 6 to 31 |

* 20 out of 31 needed to continue

| Candidate SELECT Process 511 | Score |
|---|---|
| Sell the opportunity | 1 to 6 |
| Evaluate qualifications | 1 to 6 |
| Location Considerations | 1 to 6 |
| Estimate Family Support | 1 to 6 |
| Compensation & Expectations | 1 to 6 |
| Timing Determination | 1 to 6 |
| | 6 to 36 |

* 24 out of 36 needed to continue

If TOTAL is 20 on the (client side), or 24 (candidate side) then you are good to go on to the next step, if either score is less than required then the entity or candidate needs to reconsider.

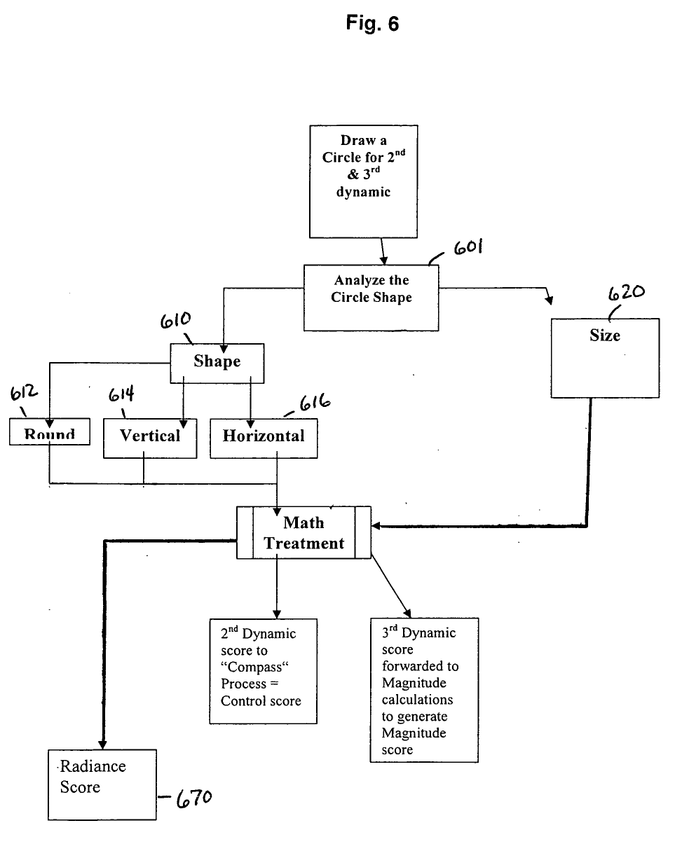

The next step is the Client Radiance process 553 and the candidate radiance process 513. FIG. 6 details the radiance processes 513 and 553.

The Radiance process 513,553 measures how expansive/restrictive a person's life energy is in terms of influence and control within a specific space. This formula was inspired by Benedict Spinoza's theory on desire splitting into pleasure and pain. The entity can determine the size of the comparative space (by many ways such as: —square foot facilities, number of employees, sales volume, plant level, corporate level, division etc.) based on the entity's requirements or needs. Radiance is a measure of influence and control felt by a candidate or client.

Entities will need an 8.5″×11″ piece of paper to complete this process. The piece of paper will represent the size of the space that is needed to represent the Entity's needs or requirements. This process is divided into 2 sections. The first section is the span of influence and control within the candidate's work environment and the second section pertains to the Entity's “Family”. Both of these sections are evaluated and scored in the same fashion. Entities are asked to view the space from an ascended point of view several feet above the given space. Then, Entities are asked to draw a circle representing their life energy, in terms of influence and control, within that given space.

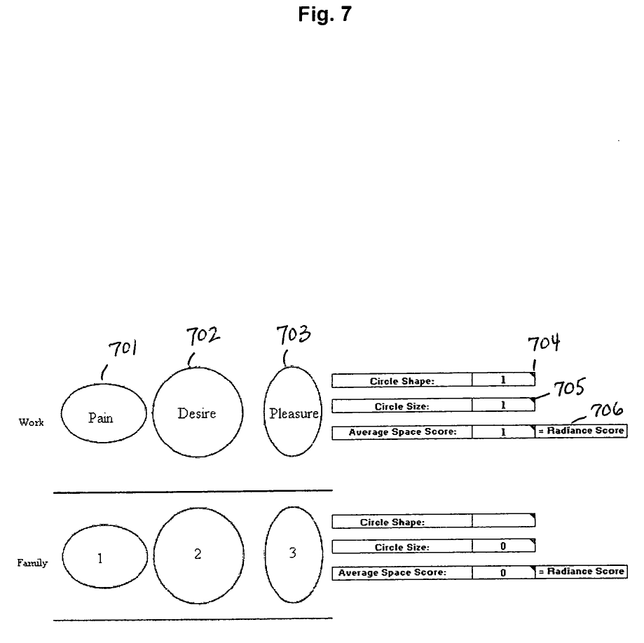

Circles are first evaluated and scored based on shape and then on size, FIG. 7. The shapes are divided into 3 categories: Pain, Desire, and Pleasure. A ‘Pain’ shape circle indicates a rational-orientated paradigm (IQ), and is scored from 0 to 3.3. A ‘Desire’ circle indicates a sensible-orientated paradigm (blend of IQ & EQ), and is scored from 3.4 to 6.6. A ‘Pleasure’ circle indicates an intuitive-orientated paradigm (EQ), and is scored from 6.6 to 9.9. Shapes 701, 702, 703 are then evaluated and scored based on size. Size 620, in inches, is determined by measuring the diameter of the circle at its widest point. The size 620 is then rounded to the nearest quarter inch. The (work) values are averaged to produce the 1^{st} ‘Average Space Score’ or ‘Radiance Score’ which later go into the calculations of the ‘Magnitude Score’ 516. This process is then duplicated for the Home (family) dynamic. The (home) values are averaged to produce the 2^{nd} ‘Average Space Score’ which goes into the calculations of the ‘COMPASS Score’ indicating a candidate's mobility and preparedness. The ‘Radiance Score’ indicates the percentage of influence to control.

### The Circles are Sized and Shaped Based on the Following Scale:

### Graph 1

| Shape | Score |
|---|---|
| Type 1 - Pain: | 0-3.3 |
| Type 2 - Desire: | 3.4-6.6 |
| Type 3 - Pleasure: | 6.7-9.9 |

### Graph 2

| Size 620 | Score | Influence to Control Ratio |
|---|---|---|
| 1″ = | 1 = | 10% Influence/90% Control |
| 2″ = | 2 = | 20% Influence/80% Control |
| 3″ = | 3 = | 30% Influence/70% Control |
| 4″ = | 4 = | 40% Influence/60% Control |
| 5″ = | 5 = | 50% Influence/50% Control |
| 6″ = | 6 = | 40% Influence/60% Control |
| 7″ = | 7 = | 30% Influence/70% Control |
| 8″ = | 8 = | 20% Influence/80% Control |
| 9″ = | 9 = | 10% Influence/90% Control |

FIG. 7 shows example of how the ellipse/circular shapes indicating a person's sense of control and influence. A person who fills the page tends to have a greater sense of control and influence, a small shape tends to indicate a person who feels small and controlled by their environment. If the edges of the shape come close to or touch the edge of the paper this also indicates a sense of influence and control over the entire environment either work or home. The radiance step 513 can be scored and analyzed as shown in FIG. 6 yielding a radiance score.

Take out an 8.5×11 piece of paper. You are life, and you need to view your life clearly. So, ascend above your daily drama. Imagine, you are 50 ft above your company, and the piece of paper represents that space. Draw a circle representing your influence & control within that space.

What is the shape of it (1, 2, or 3)λ What size is it, at its widest point, to the nearest quarter inch? After you entered your responses, turn the piece of paper over. Repeat the process for your home and family dynamics. Although the example given uses a piece of paper it will be understood that the process can be computer implemented by scanning the paper into a computer or by replicating the process electronically using a computer draw function.

FIG. 6 shows how a shape 601 is scored based on shape and size. The shape analysis 610 includes a shape that is round (circle) 612 or that is larger in the vertical 614 or horizontal direction 616. The scoring is shown in graph 1 above. The size values are shown in graph 2. So a round circle 4 inches in diameter gives a radiance score range of 7.4-10.6.

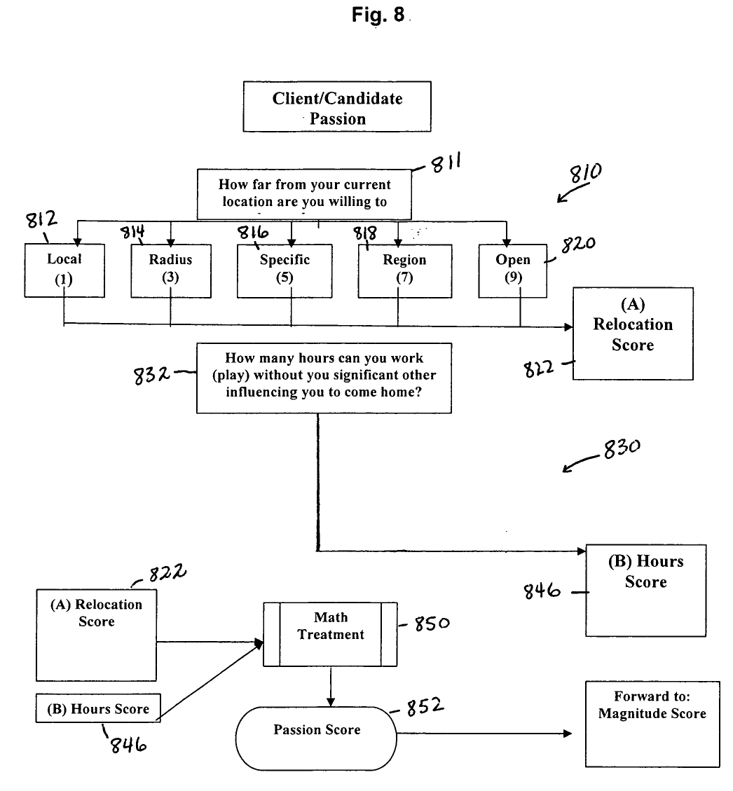

Referring back to FIG. 5 the next step is candidate and client passion 514, 554. FIG. 8 shows the details of analyzing passion. Passion 514 is based on a person's willingness to relocate and willingness to work long hours and how these are influenced by other factors such as family.

Passion measures an entity's life energy after it has been influenced from sources including hidden sources. This measurement scores the entities work ethic relevant to mobility and time contribution at work. This process is divided into 2 parts 810 & 830. Part 810: The entity is asked, how far from their current location are they willing to relocate for a great opportunity 811. The scores for Part 810 are as follows:

### A. Location

812 Local—within 50 miles=1
814 Radius—within 200 miles=3
816 Specific—to a specific location or city=5
818 Region—to a specific region(s) of a country=7
820 Open—nationwide=9.
This gives a relocation score 822.

Part 830: The entity is asked, how many hours can you work (play) without your significant other influencing you to come home, on a per day basis 832. Scores for Part 830 are as follows:

### B. Hours

8 to 9 hours per day=2
9 to 10 hours per day=4
10 to 11 hours per day=6
11 to 12 hours per day=8
12 to 13 hours per day=10.
This gives an hours score 846.

The scores from Part 810 and Part 830 are treated mathematically 850 and averaged to produce the ‘Passion’ Score 852. The ‘Passion Score’ 852 is later used in the calculations for the ‘Magnitude step 516. Example: If an entity is open in relocation, they input a 9 in the 822 block, and if they can work 10-11 hours per day, the entity inputs a 6 in the hours block 846 block. The formula is: (Location score+Hours score)/2=Passion Score or for example (9+6)/2=7.5 Passion score 852.

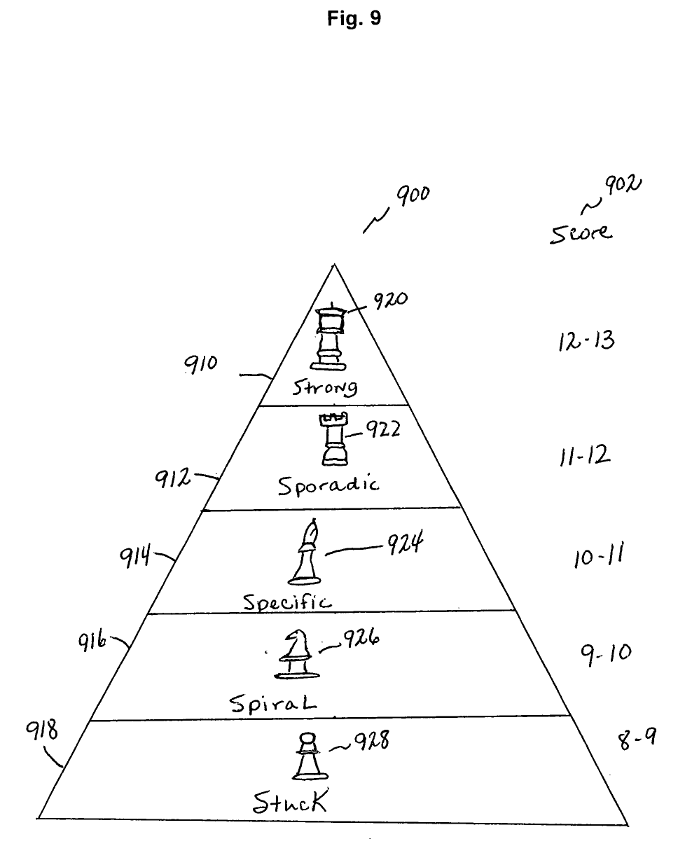

FIG. 9 shows the passion score screen shot 900. The score 902 indicates a corresponding level on the passion pyramid 900. Levels are strong 910, sporadic 912, specific 914, spiral 916 and stuck 918, the levels can include a graphic representation such as a familiar symbol, such as a chess man to give a familiar visual representation to the level. For example the strong 910 can be represented by the chess queen symbol 920, sporadic by the castle 922, specific by the bishop 924, spiral by the knight 926 and stuck by the pawn 928.

Referring back to FIG. 5, client 556 and candidate magnitude 516 scores the entity's authentic potential life energy within its social, professional, or game in life role at the current time. Magnitude 516 is a baseline probability measurement of the person's life energy interaction with others in terms of influence and control. The ‘Magnitude Score’ 516 is the Passion Score 852 and the Radiance Score 670, averaged then multiplied by 9.9 (which is originated from the—9 Survival Tendencies, and the 9 Spheres of Existence—Chi Physics) to achieve the Magnitude Score 516. Magnitude can be broke into classes associated with corresponding symbols such as chess pieces as indicators for clarification and association purposes. The Magnitude=Game Piece=Archetype=Intention=Perception=Flow=Condition=% of Control. Magnitude also equals the speed of manifestation for an entity. The Magnitude is also used to compute the level of self-absorption, and the level of contribution. These attributes are explained below. Magnitude Score formula={(Passion Score+“Work” Radiance Score)/2} multiplied by 9.9. As can be seen in the example, the [Passion score of 7.5 is averaged with the Radiance 4.5]×9.9=59.4 Magnitude, or in other terms: (7.5+4.5)/2=6, then 6×9.9=59.4. Then the score is allocated to the scales below, black bishop is indicated in the example.

### The Scale, Pieces, and Associations are as Follows:

| Magnitude | Game Piece | Archetype | Flow (S) | Condition (H) | Intention (I) |
|---|---|---|---|---|---|
| 95-100 | Cyan King | Genius | Mobis | Sovereign | Integrity |
| 88-94 | White Queen | Champion (Magician) | Strong within Nature | Freedom | Inspiration |
| 81-87 | Black Queen | Pioneer (Magician) | Strong from Nurture | Freedom | Inspiration |
| 74-80 | White Castle | Judge (Warrior) | Steady within Nature | Trust | Invest |
| 67-73 | Black Castle | Settler (Warrior) | Steady from Nurture | Trust | Invest |
| 56-66 | White Bishop | Coach (Martyr) | Specific (White/Black) | Love | Instruct |
| 47-55 | Black Bishop | Campaigner (Martyr) | Specific (Black/White) | Love | Instruct |
| 31-46 | White Knight | Comrade (Wanderer) | Spiral (Overt) | Power | Incapacitate |
| 21-30 | Black Knight | Messenger (Wanderer) | Spiral (Covert) | Power | Incapacitate |
| 13-20 | White Pawn | Convert (Victim) | Stuck within Nature | Knowledge | Inhibit |
| 6-13 | Black Pawn | Scapegoat (Victim) | Stuck from Nurture | Knowledge | Inhibit |

As Magnitude increases, a person's sense of control increases, and the Influence from negative sources decreases. The higher a Magnitude Score, the faster an entity can obtain goals. The Magnitude Score reveals the % of control to influence ratios, the % of Contribution to host, and % of Self Absorption. The % of Contribution is measured in White Keys, and the % of Self Absorption is measured in Black Keys in terms of a percent.

White Keys={Magnitude minus (mc²/1000)}×10=% of Contribution

With (m) being the Magnitude value, c is simply a constant value.

Example: (With a Magnitude of 55)=55.6% contribution rate=(59.4−49.34)×10=55.6%

For clarity: mc²/1000=[(59.4×(29.9792)²/1000]=5.56 then×10=55.6

This indicates that the entity will have 55.6% of his thought, and actions on other entity's values rather than self.

Black Keys=1/(square root of (2*Magnitude))/G

With G being the value for gravity=9.8

Example (With a Magnitude of 55)=29.8% of Self Absorption=1/(square root of (54.9×2)/G=1/3.341=0.299 or 29.9%

This person will have 29.8% of their thought and actions on themselves.

Probability 558,518—a process that measures an entity's ability to bridge their plan to goal through risk assessment in terms of a percent, from the Nurture to Nature ratios, and the percent in which the entity views itself as source. For clarification purposes, Nurture is the sum of environmental influences and conditions acting on an organism's influences such as: friends, family (upbringing), or society. Nature is the result of inborn or inherent qualities, such as part of your nature. The ‘Par-A-Dice’ Score is derived from the SUM of the Influence Die, and the Control Die. The Influence Die Score is scaled from the Magnitude Score 516 in the previous process. A Magnitude Score 516 has a corresponding Influence Die Score. The Influence Die is scaled in the following manner:

Influence Die—is Derived from the “Magnitude Score”

| If Magnitude = | Influence Die Score |
|---|---|
| 81-100 | 5 |
| 67-80 | 4 |
| 47-66 | 3 |
| 21-46 | 2 |
| 6-20 | 1 |

Control Die—Entity's are asked whether they more align to Nature or Nurture based on their level of control within their paradigm: This paragraph is designed to unlock hidden doors within their paradigm to trigger cognitions of viewing as source, and assigning themselves the proper responsibility in terms of controlling their own lives. (See below)

Influence—Is the Attention to your magnitude indicating your Intention and ability to duplicate.

Control—Is the Alignment to your Paradise indicating your ability to risk Inquiring and rewarding Measurements.

Answer: Entities are asked the following ratios, and they input the appropriate response.

| Question | Control Die Score |
|---|---|
| 100% Nurture/0% Nature | 1 |
| 70% Nurture/30% Nature | 2 |
| 50% Nurture/50% Nature | 3 |
| 30% Nurture/70% Nature | 4 |
| 0% Nurture/100% Nature | 5 |

Control Die is used in determining the RISK Taker orientation % based on the following scale and indicates the % an entity is willing to take a calculated risk. Example: If your ‘Control Die’=4, then the entity is a 80% risk taker, respectively.

Your Control Die indicates that you are willing to take a calculated Risk some percent of the time.

The grid for the Control Die is as follows:

| Control Die = | % of Risk Taker |
|---|---|
| 1 = | 20% |
| 2 = | 40% |
| 3 = | 60% |
| 4 = | 80% |
| 5 = | 100% |

Your Par-A-Dice score indicates that you put some percent attention on others which is your Paradise.

The Par-A-Dice grid is as follows:

| Par-A-Dice = | % of attention on others |
|---|---|
| 1 = | 10% |
| 2 = | 20% |
| 3 = | 30% |
| 4 = | 40% |
| 5 = | 50% |
| 6 = | 60% |
| 7 = | 70% |
| 8 = | 80% |
| 9 = | 90% |

The Par-A-Dice is the sum of the Influence Die, and the Control Die. It indicates the percent that an entity has on others form the above grid. Example: If the Par-A-Dice score=9, then the entity has 90% attention on others.

Influence Die+Control Die=Par-a-Dice Score.
Control Die is used in the following steps: the Candidate, and the Harmony Spice Scope steps.
Client Par-a-Dice: Turnstile 1, 2, and Client Spice steps.
Candidate Par-a-Dice: Turnstile 2, and Candidate Spice steps.

Manifestation Wheel (560, 520 in FIG. 5)—measures and prioritizes an entities motivations into yield scores from a entity input prioritized sequence. These scores indicate the speed that an entity can manifest their career goals and potentials within a hierarchical paradigm of responsibility while taking on the viewpoint as source, i.e. owner, or creator. The yield score indicates the entity's ability to have fair exchange in terms of a percent. This is done by allowing the entity to be source. Within employment conditions—viewing as self-employed or business owner compared to an employee, in order for the entity to view from an ascended hierarchical position of responsibility, and understand the viewpoint of the person currently in that role. This reveals the inner motivations of the entity. This philosophy is based on the principle that people will hire or retain people like themselves. This is accomplished by having the person be told that they are responsible for hiring individuals for his/her company. Their task here is to ascertain how he/she, and what his/her personnel should be motivated by. In addition, these scores should be within +/−10 points of the Magnitude score. If the Yield score is not within +/−10 to the Magnitude score, then the person is aligning to an inadequate motivator. An Inadequate Motivator is a motivator or pattern that is no longer needed, or working for the entity but still being used, and is creating a self-sabotaging reality due to past experiences that are being superimposed into their current view or situation. If the incident happened once, it will happen again. Inadequate Motivators are archetypically-based on issues in either—Needing security, Covertness, Oppressive behavior either from or on them, the lack of trust or overly trusting, or from the lack of integrity the entity feels is all around them at least at work. Even though work can create oppression in the entity's existence, the more severe oppressions may come from the home or family. Also, if the Manifestation Yield is not +/−10, then the entity has an issue with fair exchange, and the Manifestation Yield score can be viewed as a % in terms of this fair exchange ratio. This is usually associated with an oppression that has led the entity to view somewhat out-of-alignment towards integration between self and other hidden influences. This also indicates that Executive Coaching may be desired for the entity to unblock their stymied life energy flow that is resident in their view.

This manifestation process 520 is as follows:

1^{st}—The entity is given a rundown of the Career Age Stages in order to orientate them to what is typical, and where they are in relationship to it. The Career Age Stages states that entities from 20-30 years of age are in the A range, entities from 30-40 years old are in the B range, 40-50 years old are in the C range, 50-60 years of age are in the D range, and 60-70 years of age are in the E range. Each range has a Condition, Motivation, and view. We will explain each range in detail for clarity purposes.

### Typical Career Age Stages:

A: When a person enters the workforce (approx. 20-30 years of age), they are at a ‘Condition’ of wanting Technology through the ‘Motivation’ of having Expertise in their field, so they have a view on obtaining Knowledge (TEK).
B: From age (30-40), the entities are at a ‘Condition’ of wanting Challenges through the ‘Motivation’ for Advancement, so they can put Power on their expertise. (CAP)
C: From age (40-50), the entities are at a ‘Condition’ of wanting use their Passion through the ‘Motivation’ of self-Actualization, so they can educate, mentor, and hand-down their knowledge to enhance the lives of others with Love, and the contribution back to Host. (PAL)
D: From age (50-60), the entities are at a ‘Condition’ of Credibility through their years of service, and contributing back to the Host through a ‘Motivation’ on having Abundance in responsibility and in monetary values, so they have a view that flows from Trust, both receiving and granting. (CAT)
E: From age (60-70), the entities are at a ‘Condition’ of Like from the aspect that rapport is king, and they have aligned themselves with other entities that are like them through a ‘Motivation’ of Integrity, so to view their world or condition from source, and the Freedom that is associated with integrity based roles. (LIF)

2^{nd}—The entity is read or reads the information (above), the Manifestation Wheel Process 520. The entity then prioritizes the motivations from 1 to 5, based on importance to them at the current time. 1, being the most important, and 5 being the least.

### Calculations for the Manifestation Wheel Process 520:

1. Each Letter of priority is given a value based on the table below.
   A=1
   B=2
   C=3
   D=4
   E=5
2. Each position for the sequence is also given a value based on the table below.
   1^{st}=5
   2^{nd}=4
   3^{rd}=3
   4^{th}=2
   5^{th}=1
3. Then the first formula is applied. Letter * (times) Position=value
This temporary value is summed, and applied to the following breakdown and formula base.
   a. If A is in the 1^{st} position, then apply: (letter×position/2)−5=Manifestation Yield
   b. If B is in the 1^{st} position, then apply: (letter×position/1.25)=Manifestation Yield
   c. If C is in the 1^{st} position, then apply: (letter×position×1.25)=Manifestation Yield
   d. If D is in the 1^{st} position, then apply: (letter×position×1.5)=Manifestation Yield
   e. If E is in the 1^{st} position, then apply: (letter×position×2)−15=Manifestation Yield
4. Penalty Adjustments (Security based paradigms)—additional calculations based on the criteria below from the calculations above.
   a. If A is in the 2nd position, then the answer from above is divided by 1.2=Manifestation Yield
   b. If B is in the 2^{nd} position, then the answer from above is divided by 1.1=Manifestation Yield.
5. Examples of calculations

### Example 1

| Sequence | value × | position = | Sum |
|---|---|---|---|
| A | 1 | 5 | 5 |
| C | 3 | 4 | 12 |
| B | 2 | 3 | 6 |
| D | 4 | 2 | 8 |
| E | 5 | 1 | 5 |
| | | | 36 = sum total |

Since A is 1^{st}, then apply Formula: (36/2) − 5 = 13
Since A is in the 1^{st} position, therefore: 13/1.2 adjustment = 10.8 Manifestation Yield score

### Example 2

| | | | |
|---|---|---|---|
| E | 5 | 5 | 25 |
| D | 4 | 4 | 16 |
| A | 1 | 3 | 3 |
| B | 2 | 2 | 4 |
| C | 3 | 1 | 3 |
| | | | 51 |

Since E is 1^{st}, then apply Formula: (51 * 2) − 15 = 87.0 Manifestation Yield score
Since neither A or B are 1^{st} - no adjustment is needed.

### Example 3

| | | | |
|---|---|---|---|
| B | 2 | 5 | 10 |
| E | 5 | 4 | 20 |
| C | 3 | 3 | 9 |
| A | 1 | 2 | 2 |
| D | 4 | 1 | 4 |
| | | | 45 |

Since B is 1^{st}, then apply formula: (45/1.25) = 36
Since B is in the 1^{st} position, therefore: 45/1.1 adjustment = 40.9 Manifestation Yield score

The Manifestation Wheel process 520 indicates the inner self motivations, and the % of fair exchange capabilities.

Bread Winner (I/C pace ratio) score—(located at the bottom of the Manifestation Wheel)—As a bread winner, their goals are to provide and reach for career goals to enhance the family dynamic. The family dynamic's role is to support and nurture that ability for the betterment of the family as a whole. This score refers to the percent that an entity is able to reach for career goals within the influences from the family dynamic. It indicates the ratio of which the entity is able to reach, based on their current view, and the leftover percent from 100—is the amount that the family dynamic is pulling back on the bread winner.

CAKE 562, 522—Candidate Avocation Knowledge Evaluation—measures an entities current condition based in the current moment of time through the judgments (Visceral, Emotional, and Mental) below, and by following the criteria. Technology, Growth, Image, and Size
a. Advancement/Professional Growth
b. Passion/Work Delight
c. Compensation & Benefits
d. Integrity/Rapport

In the Manifestation Wheel 520, CAKE 522, and Mirror processes 528, we are examining—“Who you are” (Manifestation Wheel 520), “What you need to Do” (Mirror 528), and “What do you Have” (CAKE 522).

### The Wedding Cake

A systematic model to assess your current condition based on your judgments and the characteristics expressed in all employment opportunities, or “What you Have”. Your decision to make a career change will include these judgments which will be prioritized and modeled to help you make a sound choice. CAKE 522 includes a subjective evaluation of a candidate's opportunity in a job including their current job.

There are 3 faculties of judgment which one usually uses to feel or measure when evaluating important decisions such as a career change or employment offer, they are:
1. Visceral Judqment: “A gut consideration”—one feels deeply about. Such as, the significant factors weighed having gravity which are substantiated for the long run.
2. Emotional Judgment: “A heartfelt justification”—one feels bonded to. Such as, an appealing offer or attraction, by association that gratifies or validates one instantly.
3. Mental Judgment: “An analytical computation”—one rationalizes with. Such as, a differentiation process or logical summation to figure out or bring one to a conclusion.

A, B, and C, represent the 3 layers of a wedding cake and indicate the long run considerations of an employment condition. They are also referred to as “gut judgment”—in that if the job that you are representing gets a higher score in the ABC ranges, than what he has in his current job condition, then his gut will tell him to purse the opportunity offered. (D) represents the icing on the cake and (E) represents the bride and groom, with both D/E representing “heart judgment”—which is a justification that he needs—to make the move . . . more money, better boss etc. The wedding cake allows a clear analytical scope, a quantitative measure of what motivates him and affords him a mental profile of prioritization to use his gut, heart and mind—to make his decision with.

Judgment Calculations—are at the end of the CAKE process 522 description.

### A. Technology, Growth, Image & Size: 0 to 5

The company base foundation stabilizing all other employment values are stacked on. This value is illustrated as the largest layer of the wedding cake and consists of the solid facts that can be easily measured, which substantiates the opportunity for long run. Hence, a company with more growth, image, and size should provide the opportunity for the other factors to be more robust. Its score ranges (0 to 5), with 5 being the best. Below is a scale to score the current condition or company.
5.0—Large corporation known as a premiere company world-wide. Strong market share and growth where profits are rolled into R&D. (G. E., Wal-Mart, Proctor & Gamble, and Microsoft.)
4.0—Large organization with steady sales potential, still growing, increasing market share and a leader in their industry. Might be companies with sales in the $Billions.
3.0—Medium organization with specific growth or sales. Respected in their industry. Usually has a specific niche or product. The company is able to hold on to their current market share.
2.0—Organization with spiral, inconsistent or seasonal sales. Usually struggling to maintain or experiencing a reduction in market share.
1.0—Small local, possibly family-owned, organization with stuck sales growth. Usually hit hard by the smallest fluctuations in adverse market conditions.

### B. Advancement/Professional Growth: 0 to 4

The opportunity for professional growth or enhancement due to the company's growth, personal will and politics. Notice that enhancement is how steep your current learning curve is at your job and is relevant to your advancement. Illustrated by the second largest portion of the cake (B) is effected by (A) the company's growth and employment turnover but mostly by personal will. Score is ranged (0 to 4); 4 being the best. Below is a scale for you to score your advancement potential.

4.0—A person knows they will be promoted within months.
3.0—A person trusts a promotion within 1 to 3 years.
2.0—A person looks to be promoted every 5 years.
1.0—A person thinks they can get a promotion within 7 years.
0.5—A person figures they may only get a promotion if someone leaves.

### C. Passion/Work Delight: 0 to 3

The smallest, yet top portion of the wedding cake is passion to make a difference in people. For the professionally motivated who wants to give back, contribute, and reproduce god given talents into another. For the personally motivated who does not want to mentor, it's considered Work Content. Work Content is how well your job responsibilities match your skill set. This is a (0 to 3) score range; 3 being the best. If this score is less than 1.5, it indicates that you are not allowed to be creative and look forward to going home. If above 1.5 the person looses track of time at work, they have the opportunity to express their passion and enhance others around them. Below is a scale for you to score your passion.

2.9 to 3.0—Thomas Edison in the basement loosing track of time and misses family schedules.
2.5 to 2.9—A person who looks forward to getting to work and likes to work weekends.
2.0 to 2.5—A person who says—I wish there was more time in the day at work.
1.5 to 2.0—One that does not look forward to the weekends or coming to work after the weekend.
0.5 to 1.5—From a TGIF person down to one who watches the clock and dreads coming to work.

### D. Compensation Package (Bucks, Bonus and Benefits): 0 to 2

Illustrated by the icing on the cake represents if you are being treated fairly for your talents on a scale of 0 to 2. Your heart will let you know if you are not. This value is based more on the labor market pay and very rarely fluctuates more or less than 20% over or under paid. So this value is normally within a (0.8 to 1.2) scales unless you are desperate. Unlike the other values that have broader ranges this range is based on cost of living within location, credentials and candidate market availability. The subject on money is tricky because if you think this is your main motivation for leaving or accepting a job then you may be too superficial to see past the icing.

To often people become emotional about the offer, for if they truly were interested in bettering themselves professionally they would realize that most offers are fair or no one would work there. Below is a scale for you to score your Compensation.

1.2—A person knows they are 20% overpaid.
1.1—A person feels they are 10% overpaid.
1.0—A person is fairly paid.
0.9—A person thinks they are 10% underpaid.
0.8—A person figures they are 20% underpaid.

### E. Integrity/Rapport: 0 to 1

The bride and groom illustrate Integrity & Rapport. In other words, the chemistry and speed of the communication through an organization. Some factors to consider here are communication barriers, or the lack of them, or any hidden agendas that may exist between persons who interact with one another within an organization. Hidden agendas are an undisclosed plan. Hidden Agendas and communication barriers affect the speed of communication that flows through an organization's culture, therefore slowing productivity. The more open communication that exist within a company, the more likely they are to have shared responsibility, and higher contribution rates among its associates.

Often we will see one running from their employer because their score is less than 0.5 on this range, this is a (0 to 1) score range; 1 being the best. Again do not be fooled by the low range that this represents, as with your current boss, you may not always be married to who ever it is interviewing you. This score is often a microcosm of the bigger picture as the ethics and chemistry of upper management tend to cascade throughout all of the company characteristics, in the long run. Indeed, chemistry and trust are paramount.

1.0—You owe the company—No hidden agenda within self.
0.9—Family member in a family business—Hardly any hidden information
0.8—Working with your best friend—Inspirational information
0.7—Information is given as an investment in you.
0.6—Information is given to instruct and mentor you.
0.5—Average level of organizational politics.
0.4—Everyone seems to have a hidden agenda.
0.3—Hidden agendas that keep you in the dark.
0.2—Hidden agendas that incapacitate you.
0.1—Hidden agenda that inhibits everyone.

### Calculating the Cake—Evaluation of Your Condition

As mentioned before, we are ascertaining in this section “What You Have”. These characteristics will be used to calculate values that can be used to compare your current condition within a “now and then” framework, or with any future opportunity that may arise. You can measure your current condition now, and at any interval you deem appropriate, to assess whether your current condition is increasing or decreasing as it pertains to your career motivations. Or you can assess if a potential opportunity is actually offering enhancements to your career. By asking questions during an interview, and doing your own research based on these characteristics—you can create a side-by-side comparison format to evaluate the overall enhancement, and to ascertain the amount of consideration you may want to apply towards pursuing possibilities.

This process is initially used to calculate your current condition or company. Now that we have the characteristics defined, its time to calculate the condition.

Scoring your Condition
Place the appropriate score for each corresponding characteristic based on your current condition.
Total the scores to achieve the overall condition or potential opportunity score.
Below you will see that each characteristic score is then divided by the number that represents the best score within the category.
The key here is to obtain a percentage (%) that will be used to prioritize what you are lacking within your condition.

TABLE 1
Initial current condition (CAKE) score example;

| | | | |
|---|---|---|---|
| A | 2.00 | 40% | A value/5 = 2/5 = 40% |
| B | 2.00 | 50% | B value/4 = 2/4 = 50% |
| C | 2.00 | 66.7% | C value/3 = 66.7% |
| D | .90 | 60% | D value × 2/3 = .9 × 2/3 = 60% |
| E | .30 | 30% | E value/1 = .3 = 30% |
| Total | 7.2 | | |

Total: 7.2=This total score represents your current condition score. It is used to compare your current condition with potential opportunities in this unit of time. The best possible total score is 15. When comparing opportunities side-by-side: unless, you are a turn-around specialist, a person should see a 1.5 or higher increase in the overall condition score to make a move. A turn-around specialist may want to see a lower score indicating an organization that will benefit from their contribution.

If you have the same percentages for 2 or more values, you will need to adjust the score based on what is needed (more important) at this time. So, that the important values have a lower percentage. For example: If you have a B and D score with the same percentages, but B (advancement) is more important right now in your career. Lower the B score slightly so it has a lower percentage. If the person does not make this change, then the software will prioritize the % based on A-1^{st}, B-2^{nd}, respectively. You will see how this applies in the next step.

### Prioritizing the List

In this step, we are creating a prioritized list of what you are lacking or what areas in your current condition may need to be enhanced. This list will be crucial in determining what to shop for in your next gig for career enhancement.

In Table 2, we have taken the values from Table 1 and prioritized them from lowest to highest.

TABLE 2
Prioritized from lowest to highest

E = 30%
A = 40%
B = 50%
D = 60%
C = 66.7%

If there are 2 alike values—the software will prioritize them according to the following sequence. First A, B, C, D, and then E—respectively.

Table 2 lowest to highest sequence is used in the MIRROR process 528 for integration purposes. This sequence is then arranged from lowest (top) to highest (bottom) to create a want/need relationship or shopping list of what the person should be looking for in their current or next potential opportunity.

### Important Notes

The wedding cake vow then is: If (A) plus (B) plus (C) plus (E) is greater than your current A/B/C/E job score, then the offer (D) will be fair. The wisest know that if they agree with their prospective employers' philosophy and get a true sense of trust with them, it will spark a new marriage that will bring birth to exciting and fulfilling riches.

If your current CAKE score is beneath a 9 then you should be looking. Additionally, since the maximum score is 15, any score that is above a 10 is worth tying the knot. The average score of candidates that we place into 10 and above opportunities is 8.3.

In conclusion, this model is used to benchmark your current employment satisfaction score to that of your prospective new employment offer. It not only provides the objective rationale needed to make a decision of this magnitude; it evolves the recruiting process away from the classic sales approach to that of a progressive consulting approach.

### The Wedding Cake Additional Client Explanations for Coaches

Once you have identified the candidate as having the “must haves” indicated on the job order, get the candidate to verbally agree to confidentiality, disclosure, no counteroffers, and a 48 hour's agreement to make up his mind after receiving the offer. The written agreement of the same is called the SAIL (Sincerity Agreement of Individual's Liability) Agreement.

Obviously the candidate is not going to agree to these things unless they are seriously motivated to change jobs, so it becomes necessary to determine what is motivating him. We score his current job condition using the Wedding CAKE (Candidate Assessment Knowledge Evaluation), “a prioritization analysis of what “employment condition factors” the candidate is lacking—which is used to score and predict his receptivity to make a change—and is also used to calculate what score they will need to justify accepting an employment offer from one of our clients”.

### Employment Condition Factors

All jobs can be scored by the following ranges.

| | |
|---|---|
| A. Company Growth, Image and Size. | Score range (0 to 5) |
| B. Professional Advancement & Enhancement | Score range (0 to 4) |
| C. Work Content & Location (avg.) | Score range (0 to 3) |
| D. Salary Package (BBB) | Score range (0 to 2) |
| E. Trust, & Rapport with Boss | Score range (0 to 1) |
| Baseline Job Condition | Total (optimum is 15) |

Candidates are not knowledgeable in assessing or evaluating their employment condition. Running this process provides both the job coach and the candidate a prioritization of the candidate's motivations to possibly change jobs. The ranges are based upon a general profile of “how fast” resumes come out of a company whenever certain “factors” are lacking. For instance, if a company is downsizing, reorganizing, or shutting down—the resumes will come out of that company at a rapid pace. This condition is illustrated in a low (A) score range. So the question that a coach would ask the candidate is, “On a score of 0 to 5, score your company's growth, image and size, 5 being the best company and 2.5 being an average company, and a 0.01 being Joe's rag shop—down the alley”. The candidate goes through a comparison analysis of how his company stacks up with all the other companies and gives it a score. Often the candidate will not have a clue. A job coach may need to help him derive an objective score here.

Again, based on how fast resumes come out of a company—when people are not experiencing advancement in their organization or they are not “keeping up” with the latest in technology in comparison with other companies.

Ask the candidate, “on a score of 0 to 4, if 2 being an average advancement and enhancement rate experienced by other candidates of equal experience and credentials, what do you see your ‘score potential’ as being here at your present company?” The candidate usually has a pretty good idea at this point that if he got a low (A) score—then he will also get a low (B) score poor companies offer poor advancement opportunity. The coach may have to personalize the question by couching it in a “what was your last review like or will get advancement within the next 18 months”.

Job security only exists through enhancement and if they are not continually traversing new learning curves, they're college classmates or peers with equal experience are going to be next years “who's who” within their professional field. Since professionally motivated candidates make the best employees—and if they are not competitive in this factor, thus motivated to seek out the best employment condition for their competitiveness—they are probably not ideal candidates for clients anyway. If they are competitive, the candidate will find a score of 2.5 or less is unsatisfactory here.

Generally speaking, if candidates are not happy with their work content, “that spring in their step as they apply their God given talents” within being at cause with expanding their company's missions statement, then the resumes will come out rapidly. Or the coach can say, does your job description and the scope of your responsibilities fit like a glove? Or, are you able to give back as a mentor? If they are not happy or have lost that zest because they feel like they could do so much more, then they will get a score of less than 1.5 in this range. Also, if relocation is involved—or additional travel time is relevant to the job that a recruiter is recruiting them on—comes into play—it becomes necessary to get a location score. It is up to the consultant to discern what is needed here. If relocation and work content are relevant, then simply take both scores into account, and arrive at a mean average total. For instance, candidate has a 1.3 for his work content score and a 2.7 for his location preference score. (1.3+2.7)=4 out of 6-translated—this score now becomes a 2 out of 3. His score is 2. This can become the most important score for them as the process winds down to be used for closing at the offer stage.

Here we have a summation score that represents the ABC of the candidate's long term, day to day considerations of what it is like to be him on the job day after day, and we call this his gut judgment. In that, if when we run a hypothetical client offer score and a client's job condition get a higher score than what he currently has—then we say that he will be hungry to find out more about the job order. We say that if a man has a position that fits like a glove, in a large reputable company that is growing—then his opportunity for advancement and enhancement, his primary needs are being fed and he is satisfied. The D and E employment condition factors represent short term indications of what it is like to work at a company and can only be determined after he has already interviewed with a client. Note, we are playing matchmaker and we advise the candidate with the following: The D/E scores are the attractiveness of the offer or the “justifications”, in that our hearts tell us “we deserve” something better like more compensation or a fairer boss—than what we currently have. We can not promise our candidate that the person they interview will always be their boss or whether or not they will always get substantial pay increases in their future by going to our clients company. That is why D and E get lower scores.

If people at a company are being paid less than the industry average or what they perceive their counterparts in industry are being paid, then resumes come out of that company. We are addressing the icing on the wedding cake by the D score, in that we ask the candidate to gauge their salary, bonus and benefits in comparison to others with equal experience and credentials. Ask them, “on a score of 0 to 2, if 1 is perfectly average in terms a being paid fair what score would they range themselves in terms of fair compensation. If they give themselves anything less than a 1, it is usually a 0.7 to a 1 range. A person must use their own judgment here in terms of what is known about market industry compensation averages. If a candidate scores themselves out of skew too low—this indicates that they may be asking for too much and can not be considered reasonable.

When a candidate has a problem with their boss he may update his resume and reluctantly send it out. Be careful here because if the candidate has high ABCD scores in his profile it may indicate that he is only acutely motivated. An acute motivation to leave his company is an easy fix for the company who could easily retain him. If his boss realizes that he has activated a job search—the boss simply becomes a little more friendly and may make a counter offer. In any event, if the E score here on the candidates CAKE score is less than a 0.5 a coach can anticipate that this will chronically affect the candidates overall score in the long run. Seasoned professionals know that it is this Bride and Groom score that like a fountain, cascades down into the other factors in the cake process 522.

If the company's upper management is not treating people by the golden rule it will eventually affect the ABCD score of his total cake. A good question to ask the candidate to determine this E score is, “does your boss ask you to help him formulate the department's strategic plan, or does your boss lead you by bread crumbs of information—which indicates a hidden agenda”?

This score becomes the microcosm score of the overall macrocosm score potential in the long run.

### CAKE Judgments—Calculating the 3 Judgments

As stated above, here are the CAKE Judgments from the reference information:
1. Visceral Judgment: “A gut consideration”—one feels deeply about. Such as, the significant factors weighed having gravity which are substantiated for the long run. Gut=(A %+B %+C %)/3
2. Emotional Judgment: “A heartfelt justification”—one feels bonded to. Such as, an appealing offer or attraction, by association that gratifies or validates one instantly. Heart=(D %+E %)/2
3. Mental Judgment: “An analytical computation”—one rationalizes with. Such as, a differentiation process or logical summation to figure out or bring one to a conclusion. Mind=(Heart+Gut)/2.

SPICE Process 564/524 (FIG. 5) (SPICE stands for Selectivity, Prudence, Influence, Communication, and Empathy)—The phenomenon of how the flow (Magnitude) manifests a condition (CAKE), and the condition (CAKE) reflects back to affect the flow (Magnitude) of an entity. It measures the pressure level created by the difference in an entity's Magnitude 516 and the entity's Condition (CAKE 522). It is used for entity: pattern recognition & resolve, candidate/client compatibility indexing, Productive energy scaling, Scales of responsibility, Social acceptance, and conformation of contribution scores. The Spice 524 process is based on the same scale as the Magnitude 516 scores. There are 150 possible values within the Spice Grid, 78 are (+), 42 are (−), and 30 are (0).

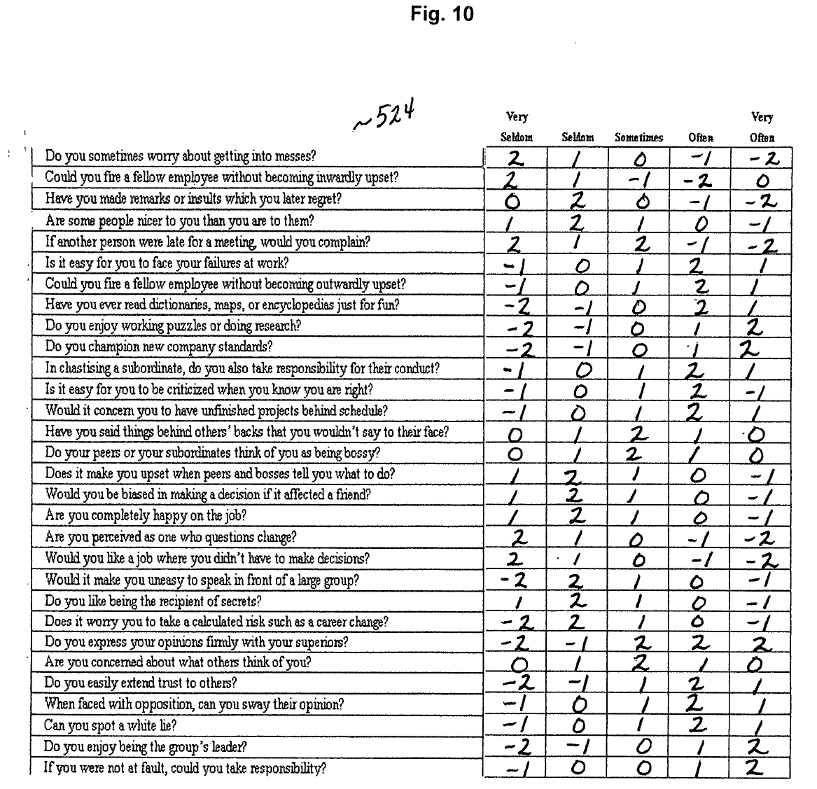

The Spice process 524 grid, FIG. 10, has values between −2 and 2. The Spice process 524 is based on the premise that everyone starts out at 60 (celerity); then values are added or subtracted based on their responses given in “The Grid”—explained later, to generate scores which indicate flows on various criteria, and pressure levels placed on both entities (candidate and client). The revealing of the flows and levels unblocks the flow based on the view that if a pattern is unwanted, once clearly viewed it will vanish. The Spice process 524, as with many of the steps in PRIZM 500, is based on familiar game formats. The Spice process 524 is based on cards—Clubs (social), Spades (responsibility), Diamonds (energy), and Hearts (Contribution).

FIG. 10 shows the Spice process 524 having 30 questions and the scoring of the responses. Of course when a person is taking the test they will not see the response values.

| Entered Value in Column “C” = | Response |
|---|---|
| 1 = | Very Seldom |
| 2 = | Seldom |
| 3 = | Sometimes |
| 4 = | Often |
| 5 = | Very Often |

### Premise

When high integrity entities come into an organization with inspiration, they may see themselves as source, but the reflection of the other sources, Group Think, mirror back a lower integrity level to the original source affecting its manifestation abilities, so they do not see themselves as source any longer. The Host entity may assume the role of source.

Spice process 524 is a sublimation process to bring harmony through pattern recognition to divert energy from a primitive impulse to a more culturally acceptable activity, and consists of a 30-point questionnaire that measures various aspects, to include:
Rational (IQ)=[(sum values from questions−5, 7, 15, 17, 18, 19, 21, 23, 24, 28)/20]×9. This score represents an entity's IQ level. The score is based on a 0 to 9 scale, and we have found that an entity with a high “Rational” score here will have a high “A” (Technology, Growth, Image and Size) CAKE 522 subcategory score and a lower “E” (Integrity/Rapport) CAKE 522 subcategory score.
Sensible (blend of Rational and Intuitive)=[(sum values from questions−1, 6, 8, 9, 13, 19, 20, 22, 27, 29)/20]×9. This score represents an entity's blend of IQ & EQ level. The score is based on a 0 to 9 scale, and we have found that an entity with a high “Sensible” score here will have a high “C” (Passion/Work Delight) CAKE subcategory score.
Intuitive (EQ)=[(sum values from questions−2, 3, 4, 10, 11, 12, 14, 16, 25, 26)/20]×9. This score represents an entity's EQ level. The score is based on a 0 to 9 scale, and we have found that an entity with a high “Rational” score here will have a high “E” (Integrity/Rapport) CAKE subcategory score and a lower “A” (Technology, Growth, Image and Size)) CAKE subcategory score.
“Pragmatic” (1-9)=Project Management skills indicator. Scale up to 9.
“Smooth” (1 or 9)=Charismatic personality indicator, comes from a pattern in spice scope scores towards ideal gives a score.
“Credit” (1 or 0)=Trust indicator—bonus for having proper Trust flow.
“Player” (1 or 0)=Risk Taker indicator
Responsibility (Spades)=Score, % of responsibility the entity is willing to take for their condition (same scale as Magnitude)
Social Acceptance (Clubs)=the mask that we all put forward for social purposes. This is the aspect we see when we first meet someone. (same scale as Magnitude)
Energy (Diamonds)=Productive Energy and an entity's horsepower score (same scale as Magnitude)
Contribution (Hearts)=The Contribution level an entity has. Score (same scale as Magnitude)
   Displayed on the Spice Scope—Scores from Previous
Magnitude 516 score
CAKE 522 score and sequence
Manifestation Yield score and sequence
Par-A-Dice Control Die Score

### Lenses

Benedict Spinoza was a 17th Century philosopher who, besides grinding lenses for telescopes, theorized that a person has 3 outlooks in life: Pain, Desire, and Pleasure which play out in our personal view, flow, and condition. This mirrors in our social plan, action and goal, creating a dichotomy between authentic and social self. This dichotomy mirror effect is life's mysterious spin that creates problematic patterns. Once mystery is clearly viewed, it ends. The person has 3 chosen conditions; I live to work (pain), I work to live (desire) or I live to play (pleasure). The PRIZM uses a mirror process 528 to ascend us above our patterns, giving a clear view of our flows and condition, from which to make illuminated and empowering choices.

These scales are used as indicators of: Social Role, Personal Power, Personal Control, Cause Flow, Social Power, Social Control, Stage Condition, Flow Effect, and Game Role.

The Attributes are Broken Further into the Following Percentage Based Attributes:
A. Percentages are score probability ratios of View, Flow and Condition. Ex. Black Pawn ratio is (1-12% Present) to (99-83% Not-Present) with an average percentage of 7 to 93%.
B. Views are inner reflections and outer projections. Ex., Black pawns view themselves with approval 93% and unlucky 7% yet project themselves as unlucky to others 93% of the time, and are approved 7% of the time by others.
C. Flows are either expansive or contractive and manifest the condition. Ex. Black Pawns contract 93% of the time from despair and superstition and expand with self-approval the other 7% of the time.
D. Condition is the state of measurable performance that is either being caused by or affecting them. Ex. Black Pawns are either causing the condition 7% of the time or are affected 93% of the time.

### These Scores are Applied to the “Lenses”.

Responsibility (spades)=Scale of Responsibility (same scale as Magnitude)
Acceptance (Clubs)=Social Acceptance (same scale as Magnitude)
Energy (Diamonds)=Productive Energy score (same scale as Magnitude)
Contribution (Hearts)=Contribution Score (same scale as Magnitude)

### Conducting the Harmony Spice Scope Process

Entities are asked the 30 questions (FIG. 10), one at a time and it's recommended for an entity to give their first impression response. Entities answer the questions with the following criteria questions & responses. The responses are: Very Seldom, Seldom, Sometimes, Often, and Very Often. The below grids, scales, answers, and questions are used to calculate the scores for the Spice process 524. After all the answers are given, the entity is referred to the “lenses” for coaching and sublimation. Also, a process called “Captain, Ship & Crew” can be used for pattern recognition. Obvious dichotomy problems can be addressed using the opposite views for sublimation. The entity is told that there are 2 ships that have the opportunity to command. The crews of both ships were polled, and they replied with answers that incorporate opposite views. 1 crew gave the answer of the entity, and the other crew gave the opposite answer. The entity is asked which crew they would rather command. This process enables the entity to see their patterns that may be in their way.

### Scoring the Harmony Spice

FIG. 10 is made up of 10 Power questions, 10 Intelligence questions, and 10 Empathy questions.

### Power Questions: 5, 7, 10, 15, 17, 18, 19, 21, 23, 24, 28

### Intelligence Questions: 1, 6, 8, 9, 13, 20, 22, 27, 29, 30

### Empathy Questions: 2, 3, 4, 9, 10, 11, 12, 14, 16, 25, 26

If you orientate to the key above, it will pertain to the following: Each answer that falls on the optimal answer is given a value of 2 points. The rest of the values follow The Grid, FIG. 10. The Grid Total=the total of values from the Grid given by entity input, Grid total could be as high as 60 and could be a negative value. Look above for clarification on what the values represent. This section refers to how scores are calculated.

### 1. Rational, Sensible, & Intuitive Attributes, & Confirmation of the Radiance

Rational Attributes—are the [(sum values from questions−5, 7, 15, 17, 18, 19, 21, 23, 24, 28)/20]×9.
Sensible attributes—are the [(sum values from questions−1, 6, 8, 9, 13, 20, 22, 27, 29, 30)/20]×9.
Intuitive attributes—are the [(sum values from questions−2, 3, 4, 10, 11, 12, 14, 16, 25, 26)/20]×9.

### 2. Credit, Smooth, Player, & Pragmatic

Credit (1 or 0)=If Q. #26 is equal to 2 then give 1 point, and display “1”.
Player (1 or 0)=If Q. #23 is equal to 1 or 2 then give 1 point, and display “1”.
Pragmatic=Number of answers with “seldom” and “often”)/2: capped @ 9.
Smooth (1 or 9)=[“very often” Grid value+“sometimes” Grid value]/2—capped @ 9.

| | |
|---|---|
| Very Often Grid | Sometimes Grid |

| # of “very often” | value | # of “Sometimes” | value |
|---|---|---|---|
| 10 or more | 10 | 10 or more | 0 |
| 9 | 8 | 9 | 1 |
| 8 | 6 | 8 | 3 |
| 7 | 4 | 7 | 5 |
| 6 | 2 | 6 | 7 |
| 5 | 0 | 5 | 9 |

3. Control and Power Points—refer to the C/P Grid which is the “Control Grid” and “Power Grid” combined. The C/P Grid, is the actual grid embedded in the software. The Control Grid and Power Grid have been separated and summarized for ease of comprehension.
Control Points—are the # of “Sometimes” answers given by an entity on the Harmony Spice scope. The Control grid scoring has been summarized below.

Control Grid

| # of sometimes = | value assigned |
|---|---|
| 0 to 2 | 5 |
| 3 to 5 | 4 |
| 6 to 8 | 3 |
| 9 to 11 | 2 |
| 12 to 30 | 1 |

Power Points—are the # of “Very Seldom” and “Very Often” answers given by an entity on the Harmony Spice Scope. The Power grid has been summarized below.

Power Grid

| # of very seldom & very often = | value assigned |
|---|---|
| 0 to 1 | 1 |
| 2 to 3 | 2 |
| 4 to 5 | 3 |
| 6 to 7 | 4 |
| 8 to 9 | 5 |

### 4. Card Scores—Responsibility, Acceptance, Energy, & Contribution

“Responsibility”—Spades=Scale of=(Grid total×3.7)+0.10
“Acceptance” (Social)—Clubs=[(Grid Total/27)×100]+[Number of answers with “very seldom” and “very often”)−capped @9]+[Magnitude Score/10]
Productive “Energy”—Diamonds=(Clubs Score)+[Grid Total+Control Points+Power Points+(# of “Seldom” and “Often” answers)/2−capped @ 9)]−[Magnitude Score/10]×2.
or
[(Grid Total/27)×100]+[Number of answers with “very seldom” and “very often”)−capped @9]+[Magnitude Score/10]+[Grid Total+Control Points+Power Points+(# of “Seldom” and “Often” answers)/2−capped @ 9)]−[Magnitude Score/10]×2.
“Contribution” Score—Hearts=[Grid Total×3)−[Grid Total+Control Points+Power Points+(# of “Seldom” and “Often” answers)/2−capped @ 9)]−[Magnitude Score/10]×2.
“Compass” Score—Total from the Compass Process is displayed.

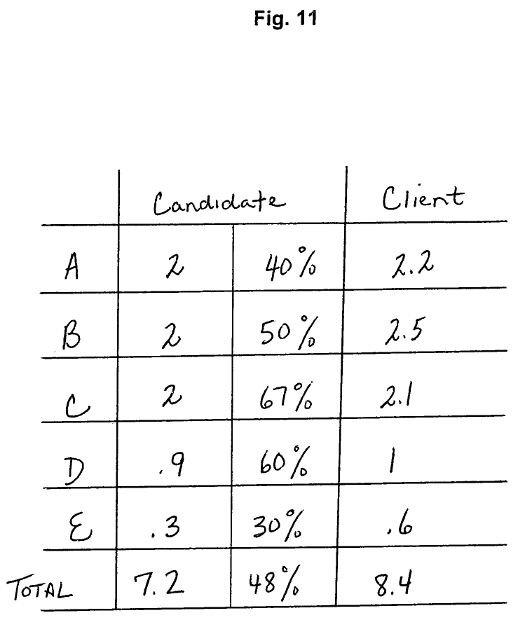

Turnstile 1 step 566—(Client Condition)—(entity's Potential Condition)—Turnstile (566 in FIG. 5) is an entity process that orientates the potential entity (client) with how the opportunity will be orientated to, and compared to the other entity's condition (candidate) in a comparative sheet that allows an entity to view the information between their current and future potentials. It will contain the CAKE 522 Scores from the client or entity's potential condition with its corresponding Par-A-Die Scores. FIG. 11 shows an example of the client CAKE and Candidate CAKE scores compared. The scores match closely except for the ‘E’ scores. For the candidate the comparison represents an opportunity to improve condition from 7.2 to 8.4 total. This amount of improvement is significant but may not be enough for the candidate to jump to the new job.

Turnstile 2 (526 FIG. 5)—is an entity process as a combination, comparative sheet that allows an entity to view the information between their current and future potentials in a baseline format. It is located immediately following the Spice Scope process 524 (candidate). As in the previous description for Turnstile 1, the entity current had not been determined, but after the CAKE process (candidate) this value was determined as is represented below. This process displays the Current CAKE Score (candidate), and the Potential opportunity CAKE Score (client) for comparison with their corresponding Par-A-Dice Scores.

| | |
|---|---|
| A. CAKE = 7.2 (current condition) | B. CAKE = 8.4 (Potential) |
| = Represents an entities current condition | = Represents an entities |
| | potential |

### C: Additional Comparative Information

Par-A-Die Score (current—candidate vs. potential—client)
Same Spice scores as above next to picture.

Here an entity can directly compare their current condition (CAKE) score vs. the potential opportunity (CAKE). Entities should have an increase in condition before pursuing an opportunity, but certain Magnitude levels can actually move into a lesser condition, in order to be the hero, such as a turnaround specialist. Below is a baseline scale to use for ‘How much increase should you need?’

Even though later in the RING process (530), an entity may change this score. In the RING process 530, the process will be orientated from 3 views, where the entity can choose. The bottom line here in Turnstile 2, FIG. 11, is that the entity can see their condition of 7.2 will be enhanced to a possible 8.4. The entity is looking at a 1.2 increase in condition. The CAKE subcategory scores for this entity are also displayed.

### The Scale is Below.

| If Magnitude = | Increase or Decrease in Condition |
|---|---|
| 81-94 | −2.0 (the entity is high powered enough to move into a |
| | lesser condition - Ex. as a turnaround agent) |
| 67-80 | −1.0 (the entity is high powered enough to move into a |
| | lesser condition - Ex. as a turnaround agent) |
| 47-66 | 0.0 (the entity can take a lateral at this level) |
| 21-46 | 1.0 (entity should need an increase in the entity's |
| | condition) |
| 6-20 | 2.0 (entity should need an increase in the entity's |
| | condition) |

Mirror (568, 528 Fiqure 5)—An alignment model of integration that provides a key for unlocking the dichotomies between reactive (CAKE) and proactive (Manifestation Wheel) motivators in order to create a shopping list for future opportunities. When confronted with these dichotomies, an entity will choose which indices are more prevalent to them in this moment in time. This sequence is used for interviewing purposes (shopping list), alignment to Host dynamics (mission statement), and unblocking their flows between their current condition and self, or the optimum condition. Below is the introduction to the Mirror process 528.

### Mirror Intro

Anything which is unwanted and yet persists, if thoroughly viewed will vanish. Ascended above your patterns, see how your dynamics is affecting your role and vice versa.

Your CAKE 522 condition (reality) is like looking in your fridge to make a shopping list. You go to the store (interview) to get what you are out of, like bread, milk and cheese (money, rapport, challenge). So the lowest score on the CAKE process 524 surfaces as your primary shortage or need.

Your manifestation wheel is the philosophic viewpoint that reflects your optimum condition. This manifests via your motivations into actions, like a ray of light (velocity) flows from its potential (battery), through its fixed or fluid viewpoint (lens) affecting your life energy which permeates the condition and becomes proactive or reactive (motivated) and sparks into actions. These actions have flows (stuck, spiral, specific, sporadic, strong) like chess pieces on a condition board. Flows become patterns. The key to unlock your Dynamic authentic self is to align your condition with your philosophy in a congruent flow through all 5 variable-need motivators listed as “A, B, C, D, E” in the CAKE 522 process.

Stay ascended above the subjective drama of your game. Look at the original manifestation wheel, and reference your career motivation age segment to determine your optimum MAP sequence to align these variables into a congruent flow you will commit to. Reference your Mirror 528 scores to predict how fast your new action plan will move you from Labor Force to Labor Freedom.

From a left to right orientation, choose a view or condition that is more relevant to you at this time. Place the response in the motivation block. Continue through the process to arrive at your new motivation sequence.
i.e. if your Mirror 528 scores are lower than your original SPICE 524 scores, then stay where you are.

### Orientating to, and Scoring the Mirror Process 528

After completing the CAKE 522 and the Manifestation Wheel processes, the CAKE values are inverted. The inverted CAKE sequence and the Manifestation Wheel sequence are forwarded to the Mirror page in a 5×3 square integration cube. The original sequence & the inverted sequence for the CAKE, and the original Manifestation Wheel are below. To explain this in more detail, please refer to the following example.

### Example

| Original CAKE sequence | Inverted CAKE |
|---|---|
| (what entity has) | (what entity lacks) |
| C | E |
| D | A |
| B | B |
| A | D |
| E | C |

RING 530—an entity comparative and commitment process that allows the entity to view their transparent information in order to reach a commitment as it pertains to the Condition (CAKE 522), theirs and the potential opportunity CAKE 562. The below scale is used for baseline commitments. The scale states that if an entity is at a particular Magnitude 516, then they are capable of having an increase or decrease in the Condition (CAKE) score as they move to a potential opportunity. However, these values are a baseline; the reality is what the entity agrees too from one of the three views. The RING 530 gives multiple views of the condition scores. It gives: 1) Snapshot (CAKE vs. CAKE straight orientation), 2) Shopping List (Inverted CAKE Sequence—candidate vs. Potential opportunity CAKE) FIGS. 11, and 3) Commitment (entity Mirror Integration Sequence—candidate vs. Potential opportunity CAKE). These are described in detail below. The increase or decrease in the condition score relates to the overall CAKE score not its individual subcategories. Example, an increase in the following subcategories will produce a 2.0 increase in the overall condition score=1.0 in the A score, with 0.6 in the B score, and a 0.4 increase in D will produce a 2.0 increase in the overall condition score, or going from a 6.8 CAKE score to a 8.8 CAKE score.

| If Magnitude = | Increase or Decrease in Condition |
|---|---|
| 81-94 | −2.0 (the entity is high powered enough to move into a |
| | lesser condition - Ex. as a turnaround agent) |
| 67-80 | −1.0 (the entity is high powered enough to move into a |
| | lesser condition - Ex. as a turnaround agent) |
| 47-66 | 0.0 (the entity can take a lateral at this level) |
| 21-46 | 1.0 (entity should need an increase in the entity's |
| | condition) |
| 6-20 | 2.0 (entity should need an increase in the entity's |
| | condition) |

In the previous example in Turnstile 2, the entity (candidate) is in a 7.2 condition (CAKE), and their potential opportunity is an 8.3 condition (CAKE). Under the RING process and according to the scales above, the entity should be of at least a 21 in Magnitude to pursue this opportunity.

RING PROCESS 530: The Ring process 530 has the following 3 views—Snapshot, Shopping List, and Commitment.

To explain these views, we need to revisit the Potential opportunity CAKE score (client), and the breakdown of the subcategories.
1. Snapshot—the snapshot is a side-by-side comparison of the CAKE scores (both entities) in a straight forward fashion. Under this view the entity is comparing his/her current condition CAKE 522 directly of 7.2 with the 8.3 condition CAKE 562 of the potential opportunity. FIG. 11.
2. Shopping List—the shopping list is a side-by-side comparison of the CAKE score of the potential opportunity 562 and the Inverted CAKE score of the entity (candidate)—what the entity is lacking in their current condition.
So, the Shopping List uses the information of the inverted CAKE score as the sequence for a CAKE process. The next step is to relate the new information from your view and Inverted CAKE sequence. We now use the criteria of E=0 to 5, D=0 to 4, C=0 to 3, B=0 to 2, and A=0 to 1. We accomplish this by superimposing the data as in the illustration below.
3. Commitment—the Commitment is a side-by-side comparison of the CAKE score of the potential opportunity 562, and the Mirror Integration sequence as a CAKE score of the entity (candidate). While attending the interview, the entity (candidate) uses the CAKE process 522 with the Mirror Integration sequence for their criteria to reassess the potential opportunity from his/her new desired view. This is done in the following manner. First the entity gathers the information from the interview, and their sequence from the earlier Mirror process.
After the Interview Information—the entity evaluates the potential opportunity in the same fashion, as they did for their current condition. These values represent the scores the entity (candidate) scored the potential opportunity after the interview. Then the candidate can compare their current condition with the future condition based on the new job opportunity.

The Commitment uses the information of the Mirror Integration sequence as the sequence for a CAKE process. The next step is to relate the new information from your view and Inverted CAKE sequence. We now use the criteria of E=0 to 5, A=0 to 4, B=0 to 3, D=0 to 2, and C=0 to 1. We accomplish this by superimposing the data as in the illustration below.

Turnstile 3—is an entity process as a combination, comparative sheet that allows an entity to view the information between their current and future potentials with the new (agreed to) RING score. This process displays the Current CAKE Score (candidate), and the Potential CAKE Score (client) for comparison with their corresponding Par-A-Dice Scores. The difference with Turnstile 3 is that the entity (candidate) chose which way to view, so the RING is now a COMMITMENT. The candidate has sublimation and clarity from their view as it pertains to the potential opportunity, and gives a verbal commitment to the potential opportunity since the gray areas have been lifted—no excuses.

STARR 570—A time saving and quantifying process used to score the potential opportunity. This process is used to ensure that an entity's expertise and contribution are not wasted on clientele that can not align to their purpose at hand. The STARR page immediately follows the Mirror page on the client side of the PRIZM. This process, for example, would be very valuable to a recruiting firm or anyone who wants to understand the dynamics of doing business with a specific entity. The criteria and scoring is as follows:

a. Specialty: (entity target market)
b. Timing: (the entity's sense of urgency)
c. Agreeable: (entity's willingness to: confidentiality/disclosure/schedule management)
d. Reality: (company, position, scope, compensation, mgt. philosophy of position)
e. Rapport: (relationship with entity based on history of interaction)

Each subcategory has a maximum possible score of 5, and a grand total of 25 for the STARR process.

Below are the appropriate actions to be taken based on the STARR score.

Score Actions:

| | |
|---|---|
| 0-5 Score: | Just File Search |
| 5-10 Score: | Above and entity Referrals with References |
| 10-15 Score: | Above and Use Surfaced Files for entity Referral |
| 15-20 Score: | Above and Backwards Reference Checking |
| 20-25 Score: | Above and Managing Member Consulting |

Thus a recruiting firm might invest time into a candidate based on the results of the STARR 570 score or other scores in the PRIZM 500 process.

COMPASS—A time saving and assessment process for the entity. The COMPASS process is located immediately following the Turnstile 3 on the candidate side of the PRIZM. The COMPASS process is for ascertaining an entity's market/sale ability in order to manifest MPCs (Most Place-able Candidates), and to qualify potential entities—If entity has a score of 42 or above—start marketing. This process does require entity input for C, O, and 2^{nd} S.
C: Credentials—Education level. This is an entity input value based on the below 0-9 scale.
O: Occupation—years of experience in the entity's current field. This value is based on the below 0-9 scale:
M: Mobility—relocation availability. This is the Passion “A” or “Location” score.
P: Preparedness—do Wedding C.A.K.E. process score will represent the willingness to leave current entity.
A: Ambition—represents the ambition towards professional growth vs. personally motivated. This is the Control Die score×1.8.
S: Selectivity—how skeptical the entity's decision making process is, or how selective they are on where they work in the future. This is the Spice “Smooth” score.
S: ‘Sale’ Ability—entity's perception on how well they interview.

### Scoring the COMPASS:

Each subcategory has a possibility of 9 maximum. The COMPASS score's maximum is 63. An entity needs a score of 42 to be marketable.

C: 0 to 9: GED to Ph.D. (entity input)
GED=1
HS=2
Apprentice/Journeyman.=3
3 years=4
Assoc.=5
BS (Non-technical)=6
BS (Technical)=7
Masters=8
Ph.D.=9
   O: 0 to 9: 1 year to 20 plus years in role applying for. (entity input)
0 to 1 years=1
1 to 2=2
2 to 3=3
3 to 4=4
to 5=5
to 7=6
to 9=7
10 to 15=8
15 plus=9
   M: 0 to 9: 50 mile radius to Openness to relocate. (Passion “Location” Score).
1 to 50 mile=1
200 mile radius=3
Specific area=5
Region of a country=7
Open=9
   P: 0 to 9: Preparedness to leave current job—the entity wedding CAKE score.
9.91-15 Cake Score=4
8.91-9.9 Cake Score=5
7.91-8.9 Cake Score=6
6.91-7.9 Cake Score=7
5.91-6.9 Cake Score=8
below 5.9 Cake Score=9
   A: 0 to 9: Ambition towards professional growth versus personally motivated.
Ambition=Control Die×2—capped @ 9.
   S: 0 to 9: How skeptical the candidate's decision making process is.
Selectivity=SPICE “Smooth” Score
   S: 0 to 9: The candidate's perception of how well he interviews. (entity input)
Imagine you went on 9 interviews that you were technically qualified for. Of those 9, how many written job offers would you receive? That number out of 9 is your answer.

Total possible=63, but an entity needs a 42 to be marketable. Thus a candidate or a coach for the candidate can make career decisions 532, 574 based on several of the scores presented in the Prizm process 500. The Compass 572 score is one of these. The career decisions might include accepting or rejecting a career offer, seeking out a new job or career, getting training or going to school or relocating for example.

Although the description above contains many specificities, these should not be construed as limiting the scope of the invention but as merely providing illustrations of some of the presently preferred embodiments of this invention. As such, it is understood that the present invention is not limited to the embodiments described above, but encompasses any and all embodiments within the scope of the claims.

It will be obvious to those skilled in the art that modifications may be made to the embodiments described above without departing from the scope of the invention. Thus the scope of the invention should be determined by the claims in the formal application and their legal equivalents, rather than by the examples given.

I claim:

1. A computer implemented process for evaluating a person including the steps of:
evaluating the person's willingness to relocate based on a first set of questions and expressing that willingness as a first number;
evaluating the person's ability to work a length of time each day based on a second set of questions and expressing that willingness as a second number;
evaluating a person's sense of influence and control based on a drawing test and expressing that sense as a third number;
evaluating a person's current employment characteristics in terms of company opportunity, advancement opportunity, work satisfaction and compensation and mathematically expressing the employment characteristics as a fourth number;
and making a career choice based on mathematically combining the first, second, third and fourth numbers.

2. The process recited in claim 1 wherein said employment characteristics can be calculated for a potential career opportunity to generate a fifth number and the fourth number can be compared to the fifth number to make a career decision about the potential career opportunity.

3. The process recited in claim 1 including the steps of creating a candidate profile based on said first, second, third and fourth numbers and providing access to a web page containing the person's profile over a computer network.

4. The process recited in claim 1 including the step of expressing at least some of the first, second, third and fourth numbers as familiar game pieces to aid in coaching the person in career decisions.

5. The process recited in claim 1 wherein said first number is added to said second number and averaged to calculate a magnitude score and assigning a chess piece to the person based on the magnitude score and then calculating a degree of self absorption based on the magnitude score.

6. The process recited in claim 1 including the further step of asking the person an additional third set of questions wherein the third set of questions are divided into questions about the person's desire for power, the person's intelligence and the person's empathy and wherein the third set of questions are scored on responses being one response from the possible responses of very seldom, seldom, sometimes, often and very often and wherein a grid total score is calculated for all the questions and a secondary score is calculated based on the number of times the same response is used wherein the secondary score is used to indicate the person's pragmatism.

7. A computer implemented process for evaluating a candidate including the steps of:
evaluating the candidate's willingness to relocate based on a first set of questions and expressing that willingness as a first number;
evaluating the candidate's ability to work a length of time each day based on a second set of questions and expressing that willingness as a second number;
evaluating a candidate's sense of influence and control based on a drawing test and expressing that sense as a third number;
evaluating a candidate's current employment characteristics in terms of company opportunity, advancement opportunity, work satisfaction and compensation and mathematically expressing the employment characteristics as a fourth number;
and making a recommendation based on analysis of the first, second, third and fourth numbers.

8. The process recited in claim 7 including the further step of asking the candidate an additional third set of questions wherein the third set of questions are divided into questions about the candidate's desire for power, the candidate's intelligence and the candidate's empathy and wherein the third set of questions are scored on responses being one response from the possible responses of very seldom, seldom, sometimes, often and very often and wherein a grid total score is calculated for all the questions and a secondary score is calculated based on the number of times the same response is used wherein the secondary score is used to indicate the candidate's pragmatism.

9. The process recited in claim 8 wherein said employment characteristics can be calculated for a potential career opportunity to generate a fifth number and the fourth number can be compared to the fifth number to make a decision about the potential career opportunity.

10. The process recited in claim 8 including the steps of creating a candidate profile based on said first, second, third and fourth numbers and providing access to the candidate's profile over a computer network.

11. A computer network implemented process for evaluating a candidate including the steps of:
calculating the candidate's willingness to relocate based on a first set of questions and expressing that willingness as a first number;
calculating the candidate's ability to work a length of time each day based on a second set of questions and expressing that willingness as a second number;
calculating a candidate's sense of influence and control based on a drawing test and expressing that sense as a third number;
calculating a candidate's current employment characteristics including at least one of company opportunity, advancement opportunity, work satisfaction and compensation and expressing the employment characteristics as a fourth number;
and making a recommendation based on analysis of the first, second, third and fourth numbers.
